(19) United States
(12) Patent Application Publication
(10) Pub. No.: US 2025/0312627 A1
(43) Pub. Date: Oct. 9, 2025

(54) PERSONAL PROTECTIVE EQUIPMENT

(71) Applicant: Fromanteel Ltd, Santon, Isle of Man (GB)

(72) Inventor: John Crawshaw Taylor, Santon (GB)

(21) Appl. No.: 18/727,987

(22) PCT Filed: Jan. 10, 2023
(86) PCT No.: PCT/EP2023/050497

§ 371 Date: Jul. 10, 2024

(30) Foreign Application Priority Data
Jan. 10, 2022 (GB) 2200235.6

(51) Int. Cl. A62B 18/04; A62B 18/10; A62B 23/02; B33Y 80/00

(52) U.S. Cl. CPC A62B 18/045; A62B 18/10; A62B 23/02; B33Y 80/00

(57) ABSTRACT

There is provided an apparatus configured to enclose a volume of air around a user's head, wherein the apparatus is configured to rest on top of the head, extend past the face and sides of the head and seal around the user's neck. The apparatus includes a first assembly including a rigid holding member and a stretchable seal, wherein the seal extends from the rigid holding member and is configured to seal against the periphery of the user's neck. The apparatus further includes a second assembly including a rigid body and a rigid cap, wherein the rigid body is configured to mate with and seal against the rigid holding member of the first assembly, wherein the second assembly further includes a transparent visor that is held by the rigid body and configured to reveal the user's visage. The rigid body of the second assembly is configured to extend from the rigid holding member, around the sides and rear of the user's head, and upwards to the rigid cap, which is configured to rest on top of the user's head and carry the apparatus in use. The apparatus further includes at least one air inlet configured to permit air to travel into an interior volume of the apparatus. The apparatus further includes at least one inlet valve configured to open and allow air to travel into the interior volume upon inhalation of a user's breath. The apparatus further includes at least one outlet valve configured to open and allow air to travel out of the interior volume upon exhalation of a user's breath. The apparatus further includes a filter device that is connected to the rigid cap, and includes a filter configured to collect, neutralize, kill (or ‘inactivate’) pathogens travelling in an airflow through it. The apparatus is configured such that air travelling into the interior volume from the external environment during normal breathing has to travel through the air inlet and the filter, and air exiting the interior volume to the external environment during normal breathing has to travel via the outlet valve.

### FIELD OF THE INVENTION

The present invention relates to a new type of personal protective equipment (“PPE”) in the form of an apparatus that is a protective covering for a user's head, as well as methods of manufacturing the apparatus.

### BACKGROUND

Even after attempting to deal with the Coronavirus (COVID-19) pandemic, there are still major flaws with most items of personal protective equipment (“PPE”) that are not being addressed.

The most commonly used PPE is a face mask. These come in various options, ranging from the blueish masks used by the general public (roughly 3.0 micron filtration size) to medical grade masks used by medical professionals (e.g., FFP3 with a very small filtration size, such as 0.3 microns).

In order for such masks to be effective against airborne transmission of a pathogen, they need to fit tightly against a user's face. This ensures that air travels into the user through the filter, rather than bypassing the filter by travelling around the filter's periphery.

Often, however, it is not possible to maintain a tight fit for such masks around the user's face, and even if a tight fit is maintained this means that breathing through such masks quickly becomes difficult. This difficulty is exacerbated for very fine filters, which are hard to breathe through and as a result have a predisposition for such masks to move away from the face during normal breathing. Testing has shown that even for a tightly fitted FFP3 mask greater than 50% of the air fails to travel through the filter.

Unfortunately this means that the better a face mask is at filtering pathogens, the more difficult (and uncomfortable) it is to use effectively.

Face masks have an additional problem in that they remove a large proportion of facial expression, which can hinder communication. Although transparent areas have been proposed, this further reduces the working area of the filter, which in turn further constricts the user's breathing and increases the propensity for air to leak around the periphery of such masks.

Other types of PPE exist, such as face visors, but these are ineffective against airborne pathogens. If a pathogen is able to travel in the air passing around the periphery of a mask, then it will of course be able to travel around a visor.

Using a mask or visor also fails to provide protection against a user transferring a pathogen from their hands onto their face (e.g., via their eyes).

Face masks, visors and most other types of PPE are designed to be single-use items, causing disposal problems when they are thrown away.

The Applicant has co-pending applications that are aimed at solving various problems with existing PPE and other protective equipment, and has also conducted an extensive research program that builds on this. In the latest of these applications an apparatus was proposed “without the need for valves”. Whilst this has various advantages, the present invention is a development of this research program that is not so limited. The aim of this application is a type of PPE that is similar to the previous version, but more comfortable. Like the previous version, the present application also aims for a new type of PPE that is reusable, easy to use and comfortable, whilst at the same time being effective at preventing pathogenic transmission.

### SUMMARY

The invention provides an apparatus that is configured to enclose a volume of air around a user's head (referred to herein as an “interior volume” of air). The apparatus is configured to rest on top of the head, extend past the face and sides of the head and seal around the user's neck. Air (for example from an exterior environment of the apparatus) is permitted to enter the interior volume during normal breathing via an inlet valve and a filter located at the top of the apparatus Air is permitted to leave the interior volume during normal breathing via an outlet valve. This will be discussed in more detail below.

The apparatus is made up of several assemblies.

A first assembly comprises a rigid holding member and a stretchable (e.g., elastomeric) seal, wherein the seal extends from the rigid holding member and is configured to seal against the periphery of the user's neck.

A second assembly comprises a rigid body that is configured to mate with and seal against the rigid holding member of the first assembly. The second assembly further comprises a transparent visor that is held by the rigid body and configured to reveal the user's visage (that is, including at least the eyes, nose, and mouth and preferably the eyebrows, cheeks and chin).

The second assembly may further comprise a rear plate, which may be configured to act as a condenser to collect any moisture build up in the internal volume. The rear plate may be made from a light and/or highly conductive material (e.g. aluminium). The rear plate may be formed to be a cylindrically or conically curved surface providing inherent rigidity of the curved surface around the back of the user's head, and may be held in place by the rigid body.

The rigid body of the second assembly extends from the rigid holding member, around the sides and rear of the user's head, and upwards to a rigid cap (the second assembly may comprise the rigid cap), which is configured to rest on top of the user's head and carry the apparatus in use. The rigid body may be a separate piece to the rigid cap, or these may be integrally formed.

It should be understood that in use the top of the user's head need not directly be in contact with the rigid cap. For example, a head harness may be attached (e.g. clipped or screwed) inside the rigid cap, and the user's head may make contact with and be held in the head harness, which allows the rigid cap to rest on the top or slightly above the top of the user's head. In further examples, other intervening components can be provided between the rigid cap and the user's head to make contact with the user's head and allow the rigid cap to rest on the top of the user's head (e.g., in a more secure and/or comfortable manner).

The apparatus comprises at least one air inlet configured to permit air to travel into the interior volume (e.g., defined in the rigid cap). The apparatus further comprises at least one inlet valve configured to open and allow air to travel into the interior volume upon and during inhalation of a user's breath.

The apparatus further comprises at least one filter device that is connected to (and e.g., sits on top of) the rigid cap, and comprises a filter configured to collect, neutralise, kill (or ‘inactivate’) pathogens travelling in an airflow through it. The apparatus is configured such that air travelling into the interior volume from the external environment during normal breathing has to travel via the air inlet (as well as the at least one inlet valve; preferably, the apparatus is arranged so that the valve protects the filter from moisture from exhaled breath).

The apparatus further comprises at least one outlet valve configured to open and allow air to travel out of the interior volume to the external environment upon and during exhalation of a user's breath. Accordingly, air exiting the interior volume to the external environment during normal breathing has to travel via the outlet valve (and cannot return to the external environment via the inlet valve(s) and/or filter(s)). The arrangement thereby protects a material of the filter from moisture that might encourage mould growth on the filter material and/or degrade the structure of the filter material.

The apparatus described above provides a new type of personal protective equipment (“PPE”) that achieves the advantages of multiple existing types of PPE whilst ensuring no pathogens can be breathed in by the user and being comfortable and easy to use.

More specifically, the apparatus prevents a user from infecting themselves, by preventing them from touching their face (e.g., with contaminated fingers) and infecting themselves with pathogens, for example via their eyes, nose, mouth, lips or ears. The invention differs from protective hoods (for example) due to the rigidity of the main constituent parts (i.e., the holding member, body and cap), which form a hard shell around the user's head, which allows them to easily breathe whilst wearing the apparatus (avoiding the so-called ‘paper bag’ effect).

The visor reveals the user's visage to other people nearby allowing the user's facial expressions to be visible whilst protecting the user from contact with airborne pathogens exhaled from infected persons nearby.

The apparatus provides filtered air to the user without the need for fans or batteries.

The present invention avoids mixing of air entering and leaving the apparatus. It has been found that the mixing of air has the potential to cause a build-up of hot and humid air that leads to condensation, for example on the visor. Using separate inlet and outlet valves avoids this build-up. It has furthermore been found that using a conventional combined filter and inlet valve restricted the configuration of filter that can be used. Therefore the present invention also includes (as discussed in more detail below) the inlet valve being located downstream of the air inlet and a separate filter device that connects to the air inlet (and preferably in the form of a replaceable cartridge that plugs into the air inlet), such that the filter is located upstream thereof.

Accordingly, in an embodiment the at least one inlet valve may be located downstream of the at least one air inlet, and the filter may be located upstream of the at least one air inlet. leading The location of the at least one air inlet and the filter can cause the air entering the interior volume to travel first through the filter, then flow through the at least one air inlet and then towards and through the at least one inlet valve. A plenum or manifold may be located between the air inlet and the at least one inlet valve. Similarly, and as described below a cavity may be located between the filter and the air inlet.

Air may be permitted to enter the interior volume during normal breathing through an inlet airflow path which comprises an inlet from an external environment into the filter or filter cartridge and the air inlet which permits air into the interior volume of the apparatus. The airflow path may direct the air, via the filter and the inlet valve, into the interior volume.

The inlet valve may be located within the rigid body of the second assembly. The outlet valve may be located within the rigid holding member of the first assembly.

Accordingly, the apparatus is a complete, unified system of PPE that obviates the need for the use of multiple, less effective (or even ineffective) forms of PPE commonly used. For example, the PPE of the invention not only achieves the aims of a face mask and visor combination, but goes further to improve the effectiveness considerably and in a more comfortable manner with less breathing restriction.

The design and construction of the apparatus is such that the internal volume space surrounding the user's head is kept small and practical. Extending the apparatus to only the neck (and, e.g., keeping the holding member adjacent to the jawline) enables the build-up of CO₂ to be kept as low as possible, as required to meet the PPE regulation (EU) 2016/415 for breathable air. The apparatus is configured to be carried by the rigid member on top of the head, so that it is spaced apart from and does not rest on the shoulders in use.

An important feature of the apparatus is that the second assembly (comprising the rigid body with visor, and cap) can be detached and removed from the first assembly (comprising the neck seal) in use. This means that a user can easily detach the second assembly as a single unit, for example to drink/eat, and then reattach it to the first assembly without having to adjust or remove the neck seal. This is distinct from many types of PPE, such as hoods or helmets, where the entire device needs to be taken off in order to access the mouth, face, etc.

The apparatus may be further refined in various embodiments that will be described in more detail below.

Looking first to the filter device, this may comprise a filter cartridge that plugs into the air inlet to fix it in position.

Various types of pathogenic filter are known and the invention is not limited to one particular type. The cartridge may comprise at least one filter sheet that sits in the inlet airflow path which leads from the external environment to the interior volume. Each filter sheet may be completely sealed around its periphery, so as to maximise the filter area within the inlet airflow path and ensure that all air travelling to the interior volume from the external, surrounding environment passes through the filter. This is in contrast, for example, to the unreliable sealing against a user's face of conventional PPE.

Each filter sheet may be held substantially flat between its sealed edges, that is without any undulations, pleats or folded edges (but encompassing a single flat or curved surface), which has been found to improve the sealing and airflow characteristics.

In an optimised arrangement, the cartridge is a box (e.g., having sides formed by a quadrilateral housing), wherein two filter sheets are superimposed but separated from each other, so as to form the top and bottom surfaces of the box with a cavity therebetween. The box may be slightly bent so as to follow a contour of the rigid cap when fixed in position. Each filter sheet is sealed around its periphery to upper and lower rims of the housing, and held substantially flat between its sealed edges. The housing comprises an opening in one of the sides that is configured to mate with the air inlet to fluidly connect the cavity with the interior volume. This arrangement provides a very large filter area to minimise the pressure drop across the filter when the user breathes in (since all air going into the interior volume has to pass through the filter when doing so).

The adult human trachea ranges between approximately 250 to 350 mm² in smallest cross-sectional area. Accordingly, the opening preferably has a smallest cross-sectional flow area that is greater than about 250 mm², and more preferably greater than about 350 mm². More generally, when the apparatus is assembled a cross-sectional flow area from the external environment to the filter opening is preferably no less than 250 mm², and more preferably no less than about 350 mm².

This optimised arrangement is considered to be inventive in its own right. Therefore, an aspect of the invention is a filter cartridge for an item of PPE, the cartridge having the features of the filter box described above.

Upon plugging the filter cartridge into the air inlet, and upon an inhalation of a user's breath, air is drawn from the external environment, through each of the filter sheets and into the cavity therebetween, and then flows from the cavity into the interior volume via the air inlet and one-way inlet valve. In comparison with existing PPE, the reduced pressure drop across the large area filter and the large cross-section area of the air route, gives the user easier, more natural and less tiring breathing.

A top cover that connects to the rigid cap, and sits over contours of the cartridge (and e.g., wraps around it) may be provided to conceal and protect the filter. This prevents a user (or anyone else) from accessing the filter in use, which is in contrast to conventional face masks that are completely open to the user, who frequently needs to touch the mask to adjust its fit. The cover can permit air to travel into the filter device when connected to the rigid cap, for example through a long, narrow slit formed between the cover and rigid cap when they are connected to each other.

The inlet valve is a “one-way” valve configured to selectively permit air to travel through the inlet valve from the filter and into the interior volume. The inlet valve is located in the airflow path between the filter and interior volume, and preferably adjacent to the air inlet. Accordingly, a filter cartridge could plug into the air inlet as described above, such that the filter is upstream of the air inlet, and wherein the inlet valve is positioned downstream of the air inlet. This permits the use of a separate, customised filter, e.g. a large surface area filter (e.g., the box arrangement described above) that is not part of the valve arrangement. This is not the case for previous arrangements proposed, in which the inlet valve is part of and mounted on the filter itself, and not, for example, as part of a separate filter cartridge that plugs into an air inlet of the rigid cap as described herein.

The outlet valve is a “one-way” valve configured to selectively permit air to travel through the outlet valve and out of the interior volume to the external environment. The outlet valve is preferably located below the visor and ideally adjacent to the user's mouth and/or chin. This arrangement ensures that hot, humid air is rejected out of the interior volume as soon as possible, to reduce condensation and CO2 and increase comfort for the user.

Moving now to the first assembly, the rigid holding member thereof may comprise a substantially ovoid ring that is configured to extend around a user's chin, wherein each side of the ovoid preferably follows a respective jawline of the user and meets again at the back of their head when fitted, for example roughly at the level of the base of the user's ears. Accordingly, the rigid holding member may be angled downwards from the back of the head to the front, which means that the apparatus can accommodate various head movements and avoid touching the user's shoulders in use.

The rigid holding member may comprise internal and external ring pieces. The seal may be clamped/sandwiched between the external rings pieces and extend therefrom to seal against the periphery of the user's neck.

The rigid holding member is preferably a fixed ovoid ring that is configured to pass over the user's head into position. In other embodiments the rigid holding member may comprise moving parts such as a hinge, so instead of passing over the user's head it can split (e.g., at the front, with the hinge at the rear) to pass around the user's neck into position.

The neck seal may be manufactured from a stretchable (e.g., elastomeric) material, such as rubber, which could also be an ovoid ring that is configured to extend in a concentric manner from the rigid holding member (e.g., an upper rim of the seal clamped within a groove thereof), to the peripheral seal against the user's neck (e.g., a lower rim of the seal that is sealed around the user's neck).

It has been found that pressure differences caused by a user breathing in and out are small enough so that a tight or hermetic (e.g., vacuum resistant) seal is not required. Thus, the neck seal may be any resilient material (e.g., fabric, rubber, etc.) that urges the lower rim against the user's neck to seal around its periphery.

As mentioned above the neck seal may be configured to split if a hinged holding member is used. Alternatively, where a one-piece assembly is used the neck seal should be sufficiently resilient to allow it to be stretched over the user's head during assembly, then seal against their neck once in position.

Moving now to the second assembly, the transparent visor may be created from a continuous sheet of transparent material (for example a thin, flexible transparent material) that is held taut against the rigid body, for example to give the cylindrically or conically curved surface which provides inherent rigidity through the curved surface. As such, the visor may not substantially move when the user breathes (avoiding the so-called ‘paper bag’ effect). The visor may wrap around at least 160 degrees of the periphery of the apparatus (i.e., around the front and sides of the head).

The visor and/or rear plate may be sealed around their periphery to opposing sealing surfaces, and the apparatus may comprise a spring-loaded means (e.g., including a resilient member) configured to urge the visor and/or rear plate against the sealing surfaces, whilst retaining the desired curved shape. This ensures that the visor material and rear plate are always pulled into engagement with the sealing surfaces, for example if it is slightly displaced in use, or from slight thermal expansion and contraction. Such an arrangement will also take account of tolerances in the parts of the apparatus that hold and seal the visor and/or rear plate in position (as well as the visor and rear plate themselves). This helps provide the visor and/or rear plate as a replaceable part or parts, so that these can be easily changed if scratched or damaged in use. That is, the spring loading means ensures that a new visor or rear plate can be pulled into proper curved engagement with the opposing sealing surfaces, even if it differs very slightly in shape or stiffness from a previous visor or rear plate.

In one embodiment, the second assembly may comprise a retainer configured to hold the visor in position in a relatively loose arrangement, such as projections that extend into apertures. The retainer may comprise resilient members on each side that cooperate with cams on the rigid body (or vice-versa), wherein rotation of each cam compresses the respective resilient member and pulls the retainer closer to the rigid body, which in turn presses the visor and rear plate against the opposing sealing surfaces creating the desired curved shape.

The second assembly may be configured to mate with and seal against the first assembly as described above. To achieve this, the rigid holding member of the first assembly may comprise a sealing surface around its upper periphery, and the second assembly may comprise a sealing surface around its lower periphery that is configured to mate with the sealing surface of the holding member. A resilient/compressible seal member may be placed between the sealing surfaces to ensure an airtight seal between the two assemblies. Such a seal may be sufficient for the very small pressure changes during breathing provided by the large surface area of the filter and the large cross sections of the inlet and outlet paths to and from the internal volume.

The apparatus may comprise a spring loaded means (e.g., a resilient clip) that is configured to press and hold the second assembly against the first assembly, and compress the seal member placed between the sealing surfaces to enclose the interior volume around the user's head.

The second assembly (e.g., rigid member, rear plate and visor) comprises a rigid, substantially upright cylindrical or conical portion that extends from the ovoid ring of the first assembly. Since the periphery of the ovoid ring is intended to extend out beyond the periphery of the user's head, this portion of the second assembly is configured to extend past the user's face and sides of the head to the rigid cap. The rigid cap initially follows the transverse contour of the cylindrical or conical portion, then extends over the user's head to rest on top of it as aforesaid (e.g., via a head harness).

Generally, the apparatus is intended to be portable, and could weigh less than about 1 kg, which can be easily carried on the top of a user's head. The constituent parts combine to provide a hard, rigid shell that fits around the head and can be picked up and fitted into position without deforming or flapping/fluttering/etc. (unlike, for example, a flexible hood).

The apparatus is designed for multiple (even lifetime) use, by comprising parts that can be repeatedly sterilised, in particular the main rigid elements. The apparatus may include disposable or replaceable items, but these could be limited to the visor and filters, which could be exchanged easily as described elsewhere herein. The invention is intended to reduce the huge volume of single use PPE sent to landfill every day, as well as the cost of single use PPE (by, e.g., healthcare workers, dentists, masseurs, hairdressers, nail technicians etc.).

The apparatus is designed for long-term use and can be tailored to specific users, as opposed to the ‘one-size-fits-all’ approach to conventional PPE.

For example, the construction of the apparatus means that each separate part can be customised for different head sizes. In contrast, a face mask is typically one size, and even if it were to be made larger, you would simply get a larger mask. All the restriction to breathing and poor sealing would remain. By providing an apparatus having a separate neck piece, holding member, rigid body and (potentially) cap, these separate parts could each be dimensioned individually. This provides a much more customisable and tailored unit.

The neck seal could be dimensioned according to a user's neck size, or be provided with different sizes similar to different shirt collar sizes. Different size neck seals could be provided for the same size rigid holding member, etc.

The size/dimensions of the various parts could be tailored such that, for a given head size, the CO₂ within the interior volume always delivers breathable air as per the PPE regulation (EU) 2016/415 for breathable air.

The apparatus may then be constructed using the individually dimensioned parts to create the customised and tailored unit.

Accordingly, this creates a new type of PPE that is personal to the user, which is distinct from one-size-fits-all, disposable PPE flooding the market.

Following on from this, the apparatus may be customised in other ways. For example, the apparatus may comprise one or more electronic accessories, for example a battery for powering a number of (optional) electrically powered components. The apparatus may comprise a battery-driven cooling fan, which may be located in the rigid cap adjacent to the user's forehead. This fan could be configured to blow air around the interior volume, rather than draw air into or out from it (which is not necessary using the disclosed invention). Other add-ons such as LEDs could be located in the cap.

The invention also extends to a method of manufacturing an apparatus as described above. The method may comprise constructing the rigid holding member, rigid body and rigid cap, as well as the stretchable seal and visor, then fitting the stretchable seal to the rigid holding member so that it extends from the rigid holding member and is configured to seal against the periphery of the user's neck as aforesaid, and fitting the visor to the rigid body so that it is held by the rigid body and configured to reveal the user's visage as aforesaid. The method may be used to construct the individual and tailored unit described above, and include the step of constructing the individually dimensioned parts.

A particularly useful technique for manufacturing the rigid constituent parts of the apparatus (including, but not limited to, the rigid holding member, rigid body and rigid cap) is additive manufacturing, otherwise known as 3D printing. This is the construction of a three-dimensional object from a computer-aided design (“CAD”) model or other suitable type of digital 3D model.

In accordance with an aspect of the invention there is provided a system comprising an additive manufacturing device configured to construct one or more (or all) of the rigid constituent parts of the apparatus described above, including, but not limited to, one or more (or all) of the rigid holding member, rigid body and rigid cap.

The method of manufacturing may comprise the step of additively manufacturing (e.g., 3D printing) one or more (or all) of the rigid constituent parts of the apparatus, including, but not limited to, one or more (or all) of the rigid holding member, rigid body and rigid cap.

The invention also extends to a computer program comprising instructions which, when the program is executed by a computer of an additive manufacturing device (e.g., as described above), cause the additive manufacturing device to additively manufacture one or more (or all) of the rigid constituent parts of the apparatus, including, but not limited to, one or more (or all) of the rigid holding member, rigid body and rigid cap.

The invention also extends to a computer readable storage medium comprising instructions which, when executed by a computer of an additive manufacturing device (e.g., as described above), cause the additive manufacturing device to additively manufacture one or more (or all) of the rigid constituent parts of the apparatus, including, but not limited to, one or more (or all) of the rigid holding member, rigid body and rigid cap.

The invention also extends to a computer program comprising instructions which, when the program is executed by a computer of an additive manufacturing device (e.g., as described above), cause the computer to carry out the method steps described above that involve constructing one or more (or all) of the rigid constituent parts of the apparatus, including, but not limited to, one or more (or all) of the rigid holding member, rigid body and rigid cap.

The invention also extends to a computer readable storage medium comprising instructions which, when executed by a computer of an additive manufacturing device (e.g., as described above), cause the computer to carry out the method steps described above that involve constructing one or more (or all) of the rigid constituent parts of the apparatus, including, but not limited to, one or more (or all) of the rigid holding member, rigid body and rigid cap.

The instructions in any of the aspects described above including a computer program or computer readable storage medium may include a CAD model or other digital 3D printable model.

The 3D printable model may be created via 3D scanning (using a suitable 3D scanner), or by a plain digital camera and suitable photogrammetry software. The 3D scanning may encompass a process of collecting digital data on the shape and appearance of the rigid constituent parts of the apparatus, including, but not limited to, the rigid holding member, rigid body and rigid cap, and creating a digital model based on it.

The CAD model or other digital 3D printable model may be provided in a stereolithography file format (“STL”) or Additive Manufacturing File format (“AMF”).

Once completed, the instructions including the CAD model or other digital 3D printable model may be processed to convert the model into a series of thin layers and produce a G-code file containing instructions tailored to a specific type of 3D printer (e.g., FDM printers). This G-code file can then be printed with 3D printing client software (which loads the G-code, and uses it to instruct the 3D printer during the 3D printing process).

The additive manufacturing or 3D printing described above can include a variety of processes in which material is deposited, joined or solidified under computer control to create a three-dimensional object, with material being added together (such as plastics, liquids or powder grains being fused together), typically layer by layer.

As noted above, the invention also extends to the filter cartridge, such that an aspect of the invention is a filter cartridge for an item of PPE (e.g., the apparatus as described herein in any of its embodiments), the filter cartridge comprising two filter sheets, wherein each filter sheet is configured to collect, neutralise, kill (or ‘inactivate’) pathogens travelling in an airflow through it, wherein each filter sheet is held substantially flat between sealed edges, wherein the filter cartridge is a box comprising the two filter sheets superimposed on and separated from each other, so as to form the top and bottom surfaces of the box with a cavity therebetween, wherein the box comprises an opening in a side thereof that is configured to mate with the item of PPE to deliver filtered air thereto, wherein air is able to be drawn from the external environment, through each of the filters and into the cavity therebetween, and then flow out of the cavity via the opening as aforesaid.

### BRIEF DESCRIPTION OF THE DRAWINGS

Various embodiments of the invention will now be described, by way of example only, and with reference to the accompanying drawings in which:

FIG. 1 shows an apparatus according to an embodiment;

FIG. 2 show a side view of the apparatus of FIG. 1;

FIG. 3 shows a partly-assembled view of the apparatus of FIG. 1, and without a filter device to illustrate the air inlet in the top of the apparatus;

FIG. 4 shows the same view as FIG. 3, but with a filter cartridge plugged into the apparatus;

FIGS. 5A-5G show the assembly of the filter cartridge shown in FIG. 4;

FIG. 6 shows a cross-sectional view of the apparatus of FIG. 1;

FIGS. 7A-7D show the visor assembly for the apparatus of FIG. 1;

FIGS. 8 and 8A show cross-sectional views illustrating the clip assembly for connecting the two assemblies that form the apparatus; and

FIGS. 9A-9B and 10A-10B show respective arrangements of an inlet and outlet valve that could be used in the apparatus of FIG. 1.

### DETAILED DESCRIPTION

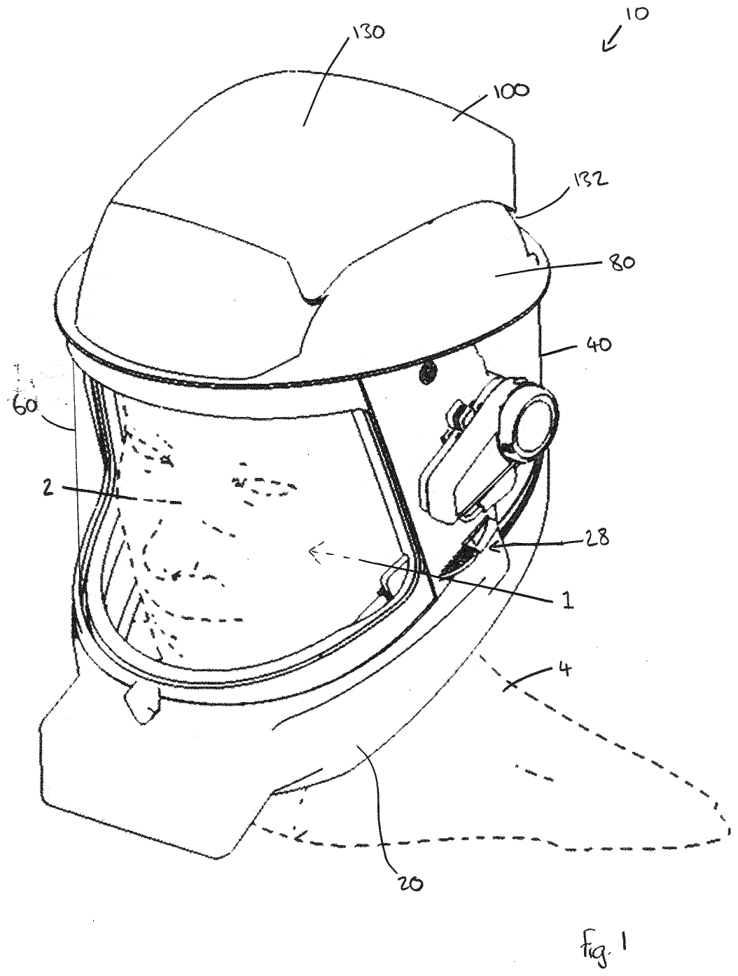

FIG. 1 shows a perspective view of an apparatus 10 for covering the head 2 of a person.

The apparatus 10 is configured to rest on top of the head 2 (e.g., via a head harness attached thereto-not shown), extend past the face and sides of the head 2 and seal around the user's neck 4 to provide an interior volume 1 of air. Air is permitted to enter and leave the interior volume 1 during normal breathing. Air entering the interior volume 1 does so via a filter device 100 and inlet valve 200 located at the top of the apparatus, whilst air exiting the interior volume does so via an outlet valve 300, as will be described in more detail below.

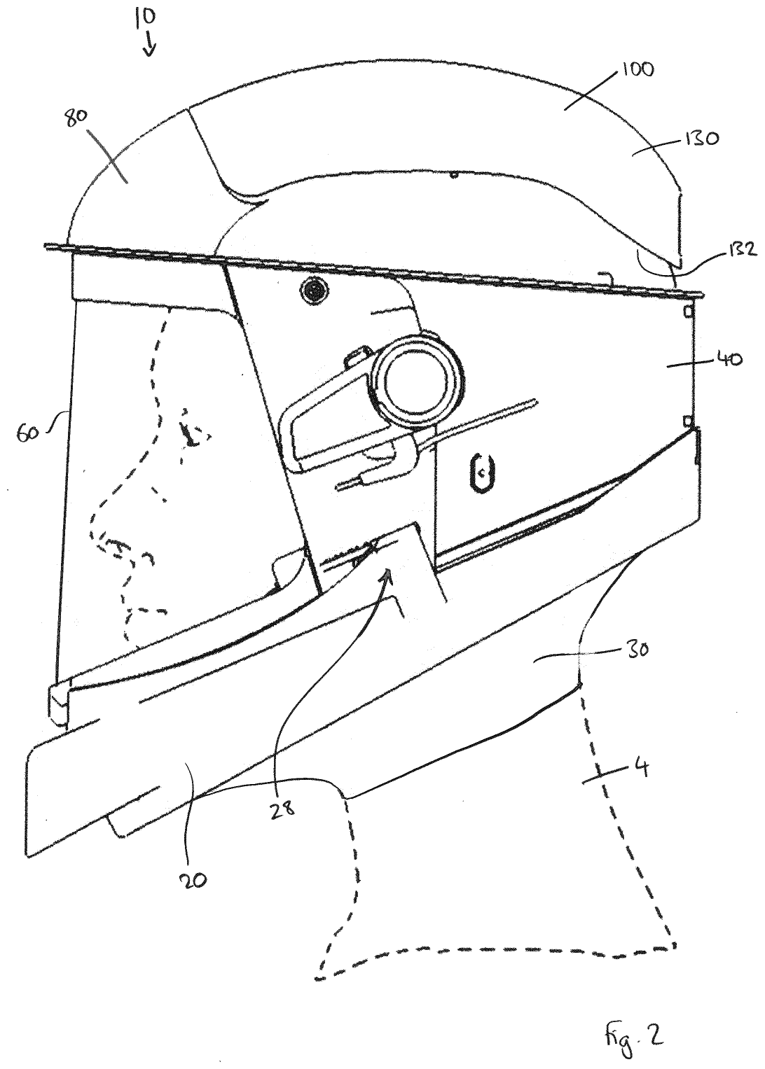

The apparatus 10 comprises a lower, rigid holding member 20 that is configured to extend around the user's chin, wherein each side of the holding member 20 follows the jawline of the user and meets at the back of their head 2, roughly at the level of the user's earlobes. This is shown more clearly in FIG. 2, from which it can be seen that the rigid holding member 20 is angled downwards from the back of the head to the front.

The apparatus 10 further comprises a rigid body 40 that is configured to mate with and seal against the rigid holding member 20. The rigid body 40 extends upwards from the rigid holding member 20, including past the face, sides and back of the user's head 1, to a rigid cap 80.

The apparatus 10 further comprises a visor 60 that extends around the periphery of the user's head 2 (e.g., at least 160 degrees of the periphery of the apparatus 10), as well as having a large vertical extension (e.g., at least about 15cm at the front of the apparatus 10) that reveals the user's entire visage.

As shown in FIG. 2, the apparatus 10 further comprises a stretchable (e.g., elastomeric) seal 30, wherein the seal 30 extends from the rigid holding member 20 and is configured to seal against the periphery of the user's neck 4.

The holding member 20, body 40 and cap 80 form a hard shell that, along with the visor 60 and seal 30 fits around the head to provide the interior volume 1. Using a hard shell means that the apparatus does not deform (e.g., flap or flutter) and advantageously retains its shape when fitted and moved around, in contrast to, e.g., PPE flexible hoods that are often used to cover a person's head.

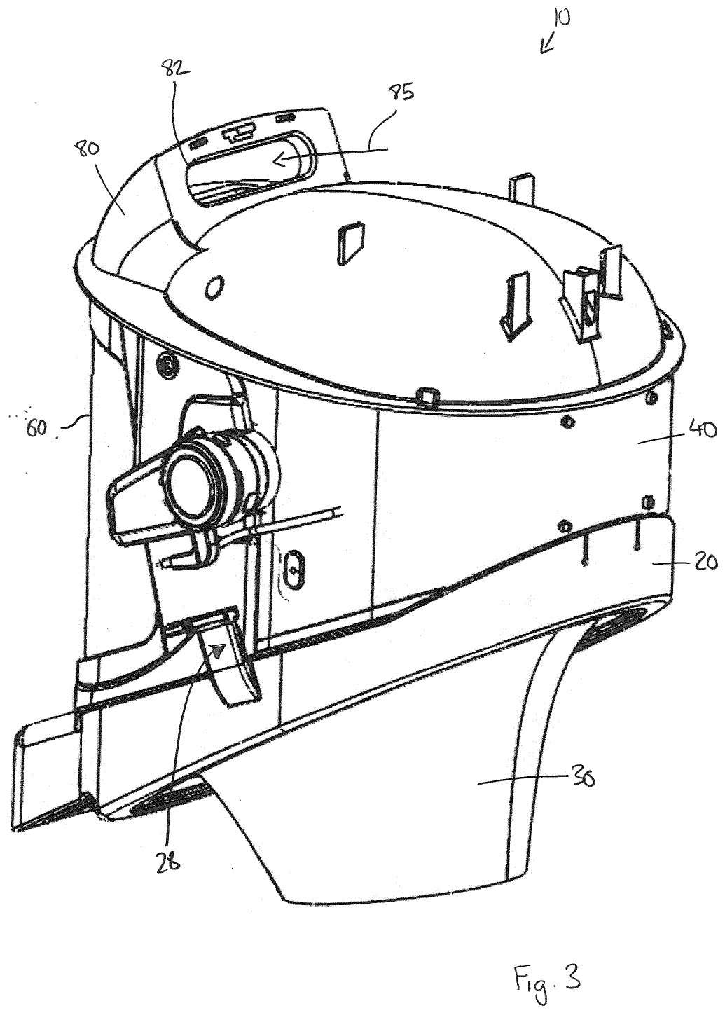

FIG. 3 shows the apparatus 10 without the filter device 100, in order to illustrate an air inlet 82 that is located in the rigid cap 80. This air inlet 82 provides the only path for air to enter the interior volume 1 during normal breathing. As is illustrated in FIG. 3, air may enter the interior volume 1 in the direction of arrow 85, and then travel down into the interior volume 1 adjacent the user's forehead via the inlet valve 200.

As discussed above the apparatus 10 is configured to collect, neutralise, kill (or “inactivate”) pathogens travelling in an airflow into the interior volume 1.

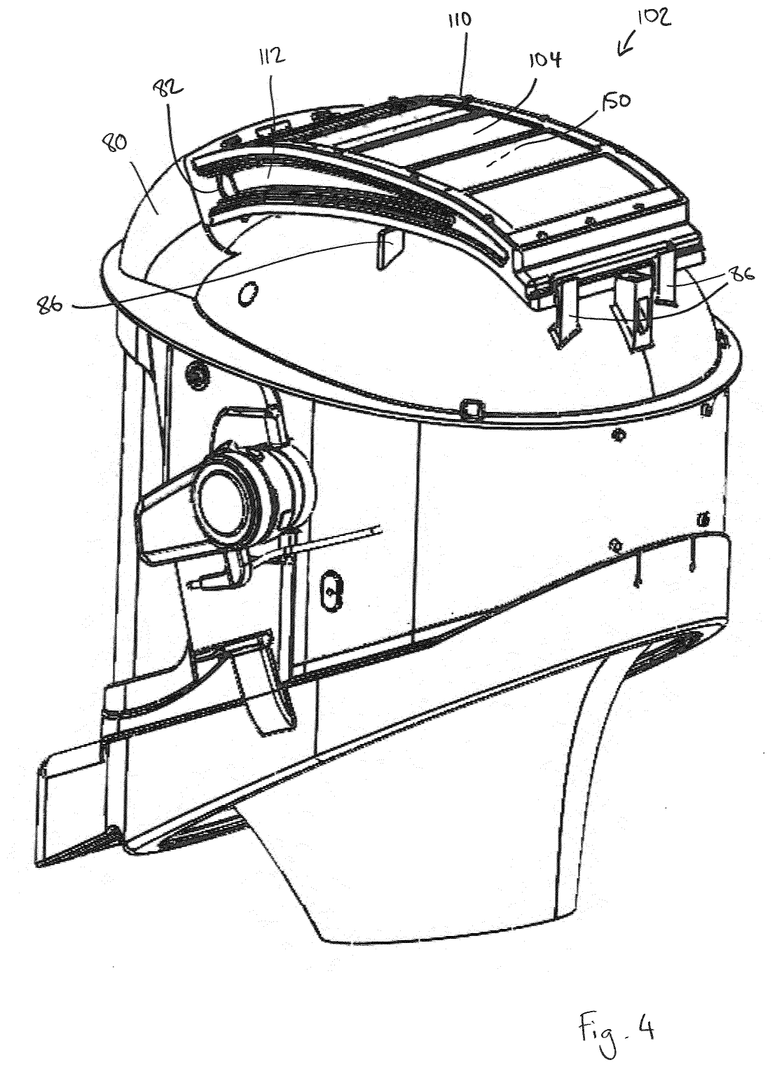

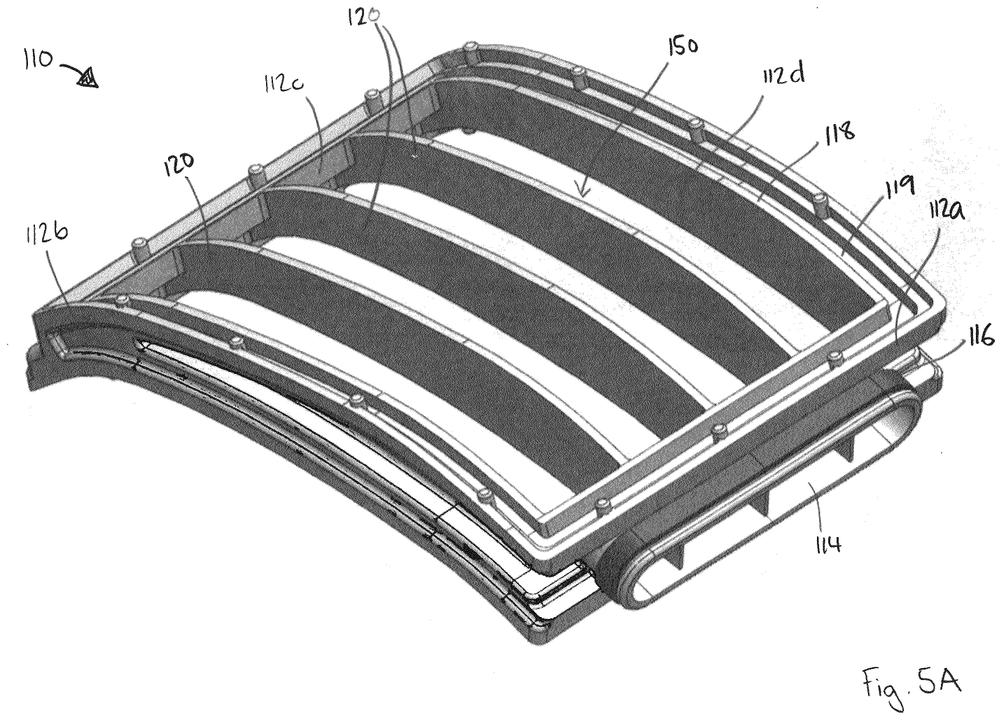

FIG. 4 shows the apparatus with a replaceable filter cartridge 102 that plugs into the air inlet 82 of the rigid cap 80 and comprises a pair of filter sheets 104 (only one of which can be seen in FIG. 4) that sit in the airflow path between the interior volume 1 and the surrounding environment. The filter cartridge 102 may sit on a plurality of spacers 86 when plugged into the air inlet 82, to hold the filter cartridge 102 in position and permit air to travel underneath the filter cartridge 102. As noted above, the replaceable filter cartridge 102 is considered inventive in its own right, and an aspect of the invention is the replaceable filter cartridge 102 as shown and described herein.

The filter cartridge 102 is box-shaped and optionally comprises a quadrilateral housing 110 (although other shapes are possible), wherein two filter sheets 104 are preferably superimposed but separated from each other, so as to form the top and bottom surfaces of the box with a cavity 150 therebetween. Superimposing in this manner maximises the usable area of the filter sheets 104.

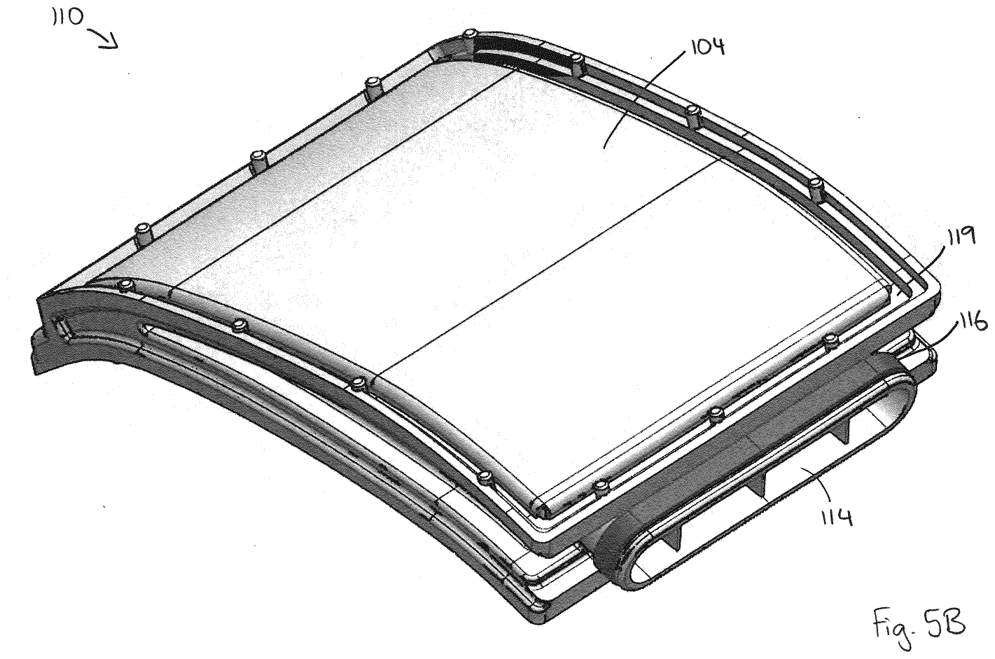

Referring to FIGS. 4 and 5A-F, the box is slightly bent so as to follow a contour of the rigid cap 80 when fixed in position. Each filter sheet 104 is sealed around its periphery to a shoulder 118 of the housing 110, wherein sealing contact is ensured by an insert 125 (described below). The housing 110 comprises an opening 114 at the front thereof that is configured to mate with the air inlet 82 to fluidly connect the cavity with the interior volume 1.

The opening 114 preferably has a smallest cross-sectional flow area that is greater than about 250 mm², and more preferably greater than about 350 mm². More generally, when the apparatus 10 is assembled, a cross-sectional flow area from the external environment to the filter opening 114 is preferably no less than 250 mm², and more preferably no less than about 350 mm². As noted above, this ensures that the opening has a cross-sectional flow area that is a relative size to the size range of an adult human trachea.

Accordingly, upon plugging the filter cartridge 102 into the air inlet 82, and upon an inhalation of a user's breath, air is drawn from the external environment, through each of the filter sheets 104 and into the cavity 150 therebetween, and then flows from the cavity 150 into the interior volume 1 via the air inlet 82 and inlet valve 200.

Referring as well to FIG. 1, the filter device 100 comprises a cover 130 that connects to the rigid cap 80, and sits over and wraps around the filter cartridge 110 to conceal the filter sheets 104. This prevents a user (or anyone else) from accessing the filter sheets 104 in use. The cover 130 permits air to travel into and surround the filter cartridge 110 through one or more gaps (in this case a long, narrow slit 132, although this type of gap is not essential) that is formed between its lower periphery and the surface of the cap 80.

FIGS. 5A-5F show the construction of the filter cartridge 102 of the filter device 110 in more detail.

The housing 110 of the filter cartridge 102 is shown in FIG. 5A and comprises four walls/sides 112a-d, with an opening 114 provided in one of the sides 112a that is configured to mate with (i.e., plug into) the air inlet 82, which may be referred to as the ‘front’ of the filter cartridge 102. A seal 116 is provided around the opening 114 and configured to seal against an opposing surface of the air inlet 82, so as to fluidly seal the opening 114 against the air inlet 82.

Two sides 112b, 112d of the housing 110 extend from the front substantially in a parallel fashion towards the rear of the filter cartridge 102, so that the side 112c of the housing 110 at the rear thereof is the same width as the side 112a at the front. This particular shape is not essential, for example the housing 110 could have sides that are curved, or flare out, etc.

A shoulder 118 is located on the housing 110 and extends around its periphery to define a trough 119 that is adjacent to the outer edges thereof. A plurality of ribs 120 are provided that extend lengthwise from the rear wall 112c towards and into the opening 114. The ribs 120 are provided for structural support and also to guide air along channels between the ribs 120 and into the opening 114.

FIG. 5B shows the housing 110 with a filter sheet 104 placed on top of the shoulder 118 and extending into the trough 119. The filter sheet 104 is configured to follow the contour of the shoulder 118 and seal around its periphery, so that air entering the cavity 150 from above can pass through almost the entirety of the upper filter sheet 104.

FIG. 5C shows the housing 110 with an insert 125 that is configured to press into the housing 110 to retain the filter sheet 104 and press its edges against the shoulder 118 so as to ensure a good sealing contact. The insert 125 comprises a number of ribs 126 for structural support and to help retain the filter sheet 104. The insert 125 may be configured to slightly deform to allow it to fit into housing 110, and may be retained by any suitable means. In the illustrated embodiment a number of heat stakes 128 are provided that are configured to deform upon heat contact, so as to retain the insert 125 in position (and ensure sealing contact for the filter sheet 104). Other embodiments are possible, however, for example a number of clips could be located around the periphery of the insert, with the insert configured to clip into the housing 110 instead.

FIGS. 5D-5F show substantially the same arrangement for the lower filter sheet 104, which is placed on top of the shoulder 118 and fits into the housing 110 in a similar manner. The lower filter sheet 104 is also retained by an insert 125, and is sealed so that air entering the cavity 150 from below can pass through almost the entirety of the lower filter sheet 104.

FIG. 5G shows a cross-section of the sealing arrangement between the filter sheets 104 and the shoulder 118/trough 119. Each insert 125 is configured to press onto a respective filter sheet 104, and comprises a rail 127 around the periphery thereof that is configured to extend into a respective trough 119. When the insert 125 is in position, as shown in FIG. 5G, the rail 127 deflects the peripheral edge 104A of the filter sheet 104 into the trough 119, and presses the filter sheet 104 against the shoulder 118 to seal the filter sheet 104 against the shoulder 118.

As described above, once the inserts 125 are correctly in position to ensure an adequate seal between the filter sheets 104 and the housing 110, the heat stakes 128 (or other means) can be activated to hold the inserts 125 in position.

Once the upper and lower filter sheets 104 are held in sealing engagement using the inserts 125, the filter cartridge 102 is complete and ready to be plugged into the air inlet 82 as described above and shown in FIG. 4.

FIG. 6 shows a cross section through the apparatus 10, including the filter cartridge 102 plugged into the air inlet 82.

Here the filter device 100 further comprises the cover 130 that connects to the rigid cap 80, and sits over and wraps around the filter cartridge 110 to conceal the filter sheets 104. The cover 130 is configured to attach to the rigid cap 80 using suitable clips 132 located at the front and rear of the cover 130, although any suitable attachment mechanism may be used.

FIG. 6 also shows the rigid holding member 20 in cross-section. This comprises a substantially ovoid ring that is configured to extend around the user's chin, wherein each side of the ovoid follows a respective jawline of the user and meets again at the back of their head when fitted, for example roughly at the level of the user's earlobes. As can be seen in both FIGS. 1 and 5, the rigid holding member 20 is angled downwards from the back of the head to the front, which means that the apparatus can accommodate various head movements since it avoids contact with the shoulders and back of the user.

In the illustrated embodiment the rigid holding member 20 is a fixed ovoid ring, but in other embodiments the rigid holding member 20 may comprise movable parts such as a hinge. As such, instead of passing over the user's head it could split (e.g., at the front, with the hinge at the rear) to pass around the user's neck into position.

An upper portion of the neck seal 30 is clamped/sandwiched between internal and external ring pieces 20a, 20b of the rigid holding member 20, and sits within a groove thereof to retain it in position. Any suitable retaining mechanism may be used, although the neck seal 30 should be retained so that it seals against the rigid holding member 20 and air cannot escape from the interior volume 1 around an upper rim thereof.

The neck seal 30 extends from the upper portion down to a lower rim 32, where the seal 30 is configured to press against the user's neck to enclose the interior volume 1. The seal 30 as illustrated is made of a stretchable (e.g., elastomeric) material, such as rubber, which extends in a concentric manner from the upper rim to the lower rim 32.

It has been found that the pressure differences caused by a user breathing in and out through the filter are small enough so that a hermetic (e.g., vacuum resistant) seal is not required. Thus, the neck seal 30 may be any material (e.g., resilient fabric, rubber, etc.) that urges the lower portion against the user's neck to seal around its periphery.

The rigid holding member 20 further comprises an outlet valve 300 configured to open and allow air to travel out of the interior volume 1 during exhalation of breath. The outlet valve 300 is a “one-way” valve (otherwise referred to as check, non-return, or retention valves, etc.) configured to selectively permit air to travel through the outlet valve 300 and out of the interior volume 1 to the external environment. The outlet valve 300 is preferably located below the visor 60 and optionally adjacent to the user's mouth and/or chin at the lower front of the apparatus 10. A preferred construction of the outlet valve 300 is provided below.

The neck seal 30 and rigid holding member 20 combine to form a first assembly of the apparatus 10.

Still referring to FIG. 6, the visor 60 is a continuous sheet of thin flexible transparent material that is held taut against the rigid body 40 using a retainer 62 and spring loaded mechanism 70 (FIGS. 7A-7D). The transparent material is held against the rigid body 40 so as to form a cylindrically or conically curved surface, providing the inherent rigidity of such a curved surface. In the illustrated arrangement the visor 60 combines with a rear sealing plate 90, both of which are held taut against rigid parts of the apparatus 10 to seal the interior volume 1. The rear sealing plate 90 may advantageously be constructed of a light metal (e.g., aluminium) that is exposed to the interior volume 1, which provides a preferred surface for condensation (to help avoid condensation on the visor 60). The rear sealing plate 90 may also advantageously be formed to be a cylindrically or conically curved surface, providing the inherent rigidity of such a curved surface.

The retainer 62 and mechanism 70 are configured to pull the visor 60 taut and ensure a good seal throughout the life of the visor 60, as well as upon replacing the visor 60 with a new one. The mechanism 70 also ensures that the visor 60 does not deform when the user breathes (avoiding the so-called ‘paper bag’ effect in combination with the use of a hard shell construction). The visor wraps around about 180 degrees of the periphery of the apparatus 10 (i.e., around the front and sides of the user's head 1).

FIG. 7A shows the retainer 62 and rear plate 90 in isolation, wherein the retainer 62 is of a shape that is configured to extend around the periphery of the visor 60.

The retainer 62 comprises a plurality of protrusions 64 that are configured to extend into corresponding apertures 66 on the visor 60 (FIG. 7B). The protrusions 64 are spaced from an inner rim 63 of the retainer 62 to leave an area 65 between the protrusions 64 and the inner rim 63. This area 65 is configured to engage sealing members that press into the visor 60 when placed in position, as will be described in more detail below.

The retainer 62 further comprises racetrack-shaped apertures 68 that are configured to receive locating pins 67 on the rigid body 40.

FIG. 7A further illustrates part of the spring loaded mechanism 70, namely a resilient wire 72 (e.g., piano wire) on each side. The wire 72 is held taut by a clip 74, and extends through an aperture 76 of the retainer 62 that may be positioned between the racetrack-shaped locating apertures 68.

FIG. 7B shows the visor 60 attached to the retainer 62 by pressing the visor into the retainer so that the protrusions 64 extend through the apertures 66. At this stage the visor 60 is fitted to the retainer 62 relatively loosely, so that although the visor 60 is held in proper position by the engagement of the protrusions 64/apertures 66, it is not held taut.

FIG. 7B also shows the rear plate 90 in position relative to the retainer 62, that is so that corresponding apertures 92 match up with the apertures 68 on the retainer 62. FIG. 7C shows the retainer 62 in isolation with the visor 60 (that is, without the rear plate 90).

Referring briefly back to FIG. 6, this shows the visor 60, retainer 62 and seals 69 in position. The seals 69 oppose the area 65 between the protrusions 64 and the inner rim 63, and extend around the entire periphery of the visor 60. A similar arrangement is used for the rear plate 90.

FIG. 7D shows the retainer 62 with visor 60 and rear plate 90 mounted onto the rigid body 40, by locating the retainer 62 and plate 90 over the body 40 using the locating pins 67. The racetrack-shaped apertures 68 permit slight movements of the retainer 62 (and visor 60/plate 90) in the direction of arrows 79.

FIG. 7D shows the mechanism 70 for pulling the visor 60 and plate 90 taut to ensure a good seal around their respective peripheries. It will be appreciated that an identical arrangement is provided on the opposite side of the retainer 62 and plate 90. The rigid body 40 comprises clips 74 that are configured to catch each respective wire 72 when the retainer 62 and plate 90 are fitted onto the body 40 as shown. The pulling of each wire 74 over its respective clip 72 pulls the retainer 62 and plate 90 into sealing contact with the rigid body 40. This in turn causes the visor 60 to be urged tightly against the opposing seals 69 around its periphery as aforesaid.

A cover plate 78 may be placed over each mechanism 70 to enclose and protect it in use. The cover plates 78 may be screwed into place, for example with screws passing through screw holes 77. The cover plate 78 may also form part of the clip arrangement 28 for pulling the first and second assemblies into engagement, described below. The geometry of the cover plates 78 may match that of the retainer 62, so that it sits flush with the front surface thereof when screwed into place.

Thus, the visor 60 and rear plate 90 are sealed around their respective peripheries to opposing seals 69. The mechanism 70 ensures that the visor material and rear plate 90 are always pulled into engagement with the seals 69. This will also take account of tolerances in the parts of the apparatus 10 that hold and seal the visor 60 and rear plate 90 in position (as well as the visor 60 and rear plate 90 themselves). For example, the visor 60 may be replaceable, so that it can be easily changed if scratched or damaged in use.

The rigid body 40 (with visor 60 etc.), rigid cap 80 and filter device 100 combine to form a second assembly of the apparatus 10, the second assembly is configured to mate with and seal against the first assembly. The second assembly therefore forms a single, rigid piece that can be attached and detached to the first assembly, whilst the first assembly is in position. This means that, during use of the apparatus, a user can easily remove the second assembly (e.g., to access the eyes, nose or mouth) without having to also remove or adjust the first assembly.

When mated together, the rigid body 40 and visor 60 extend from the rigid holding member 20 as an ovoid cylinder, around at least the sides and rear of the user's head 1, and upwards to the rigid cap 80 that is configured to rest on top of the user's head 1 (e.g., via a head harness attached thereto—not shown). The rigid body 40 may be a separate piece to the rigid cap 80, or these may be integrally formed.

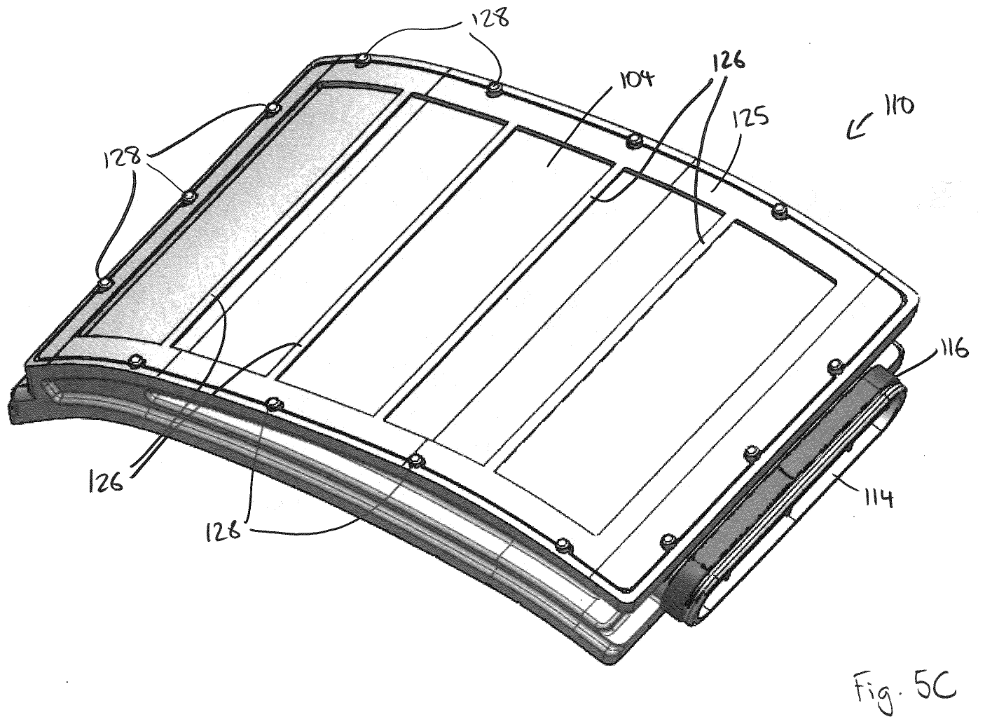

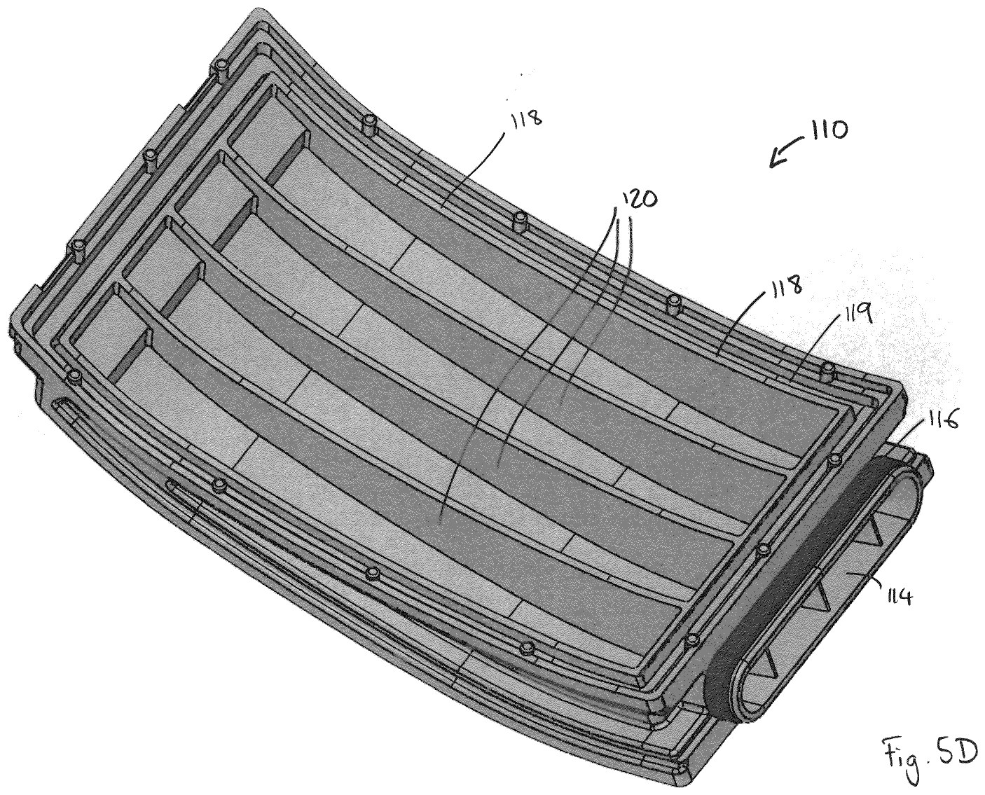

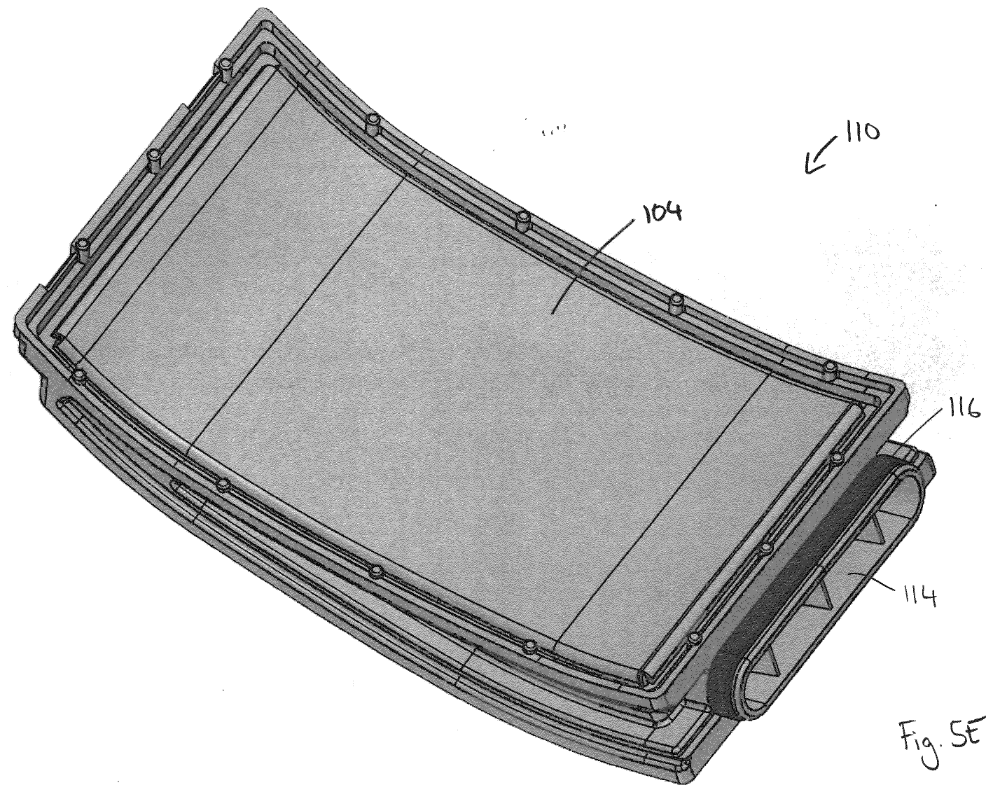

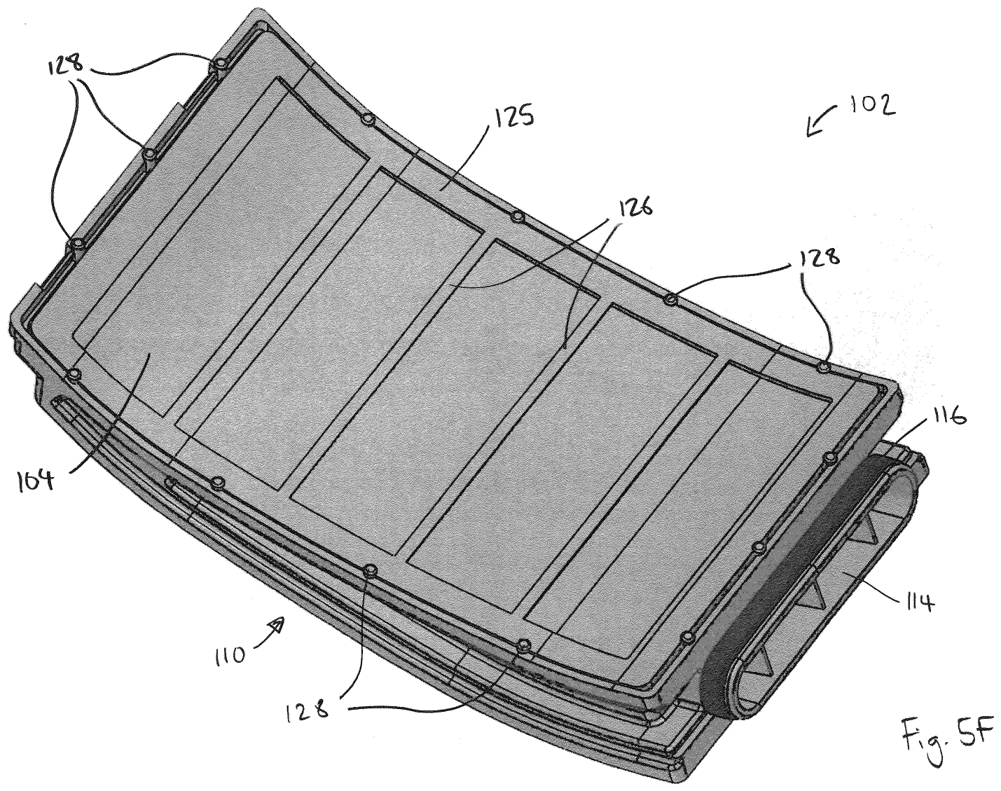

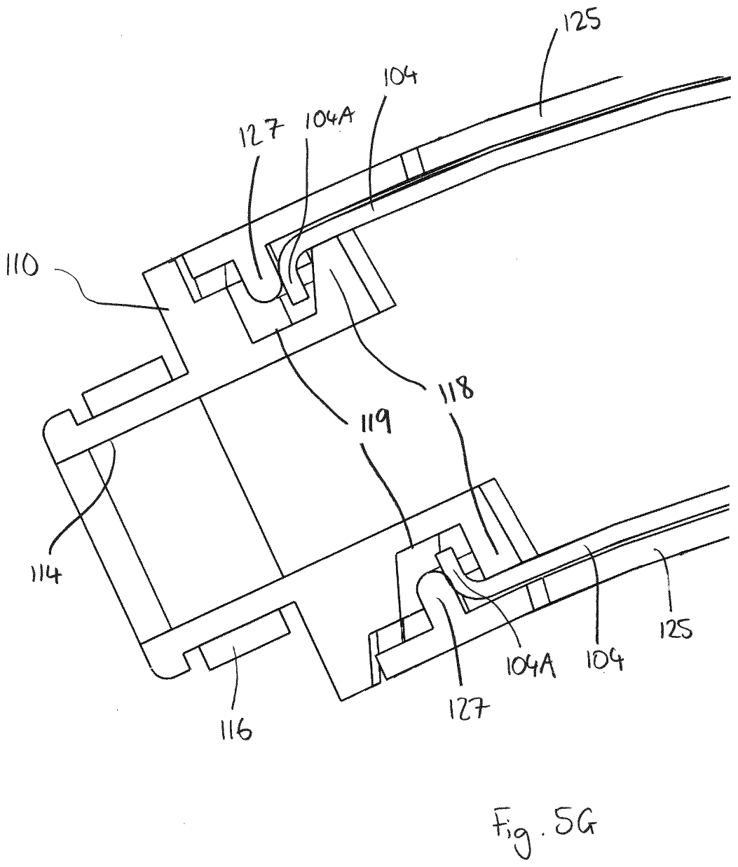

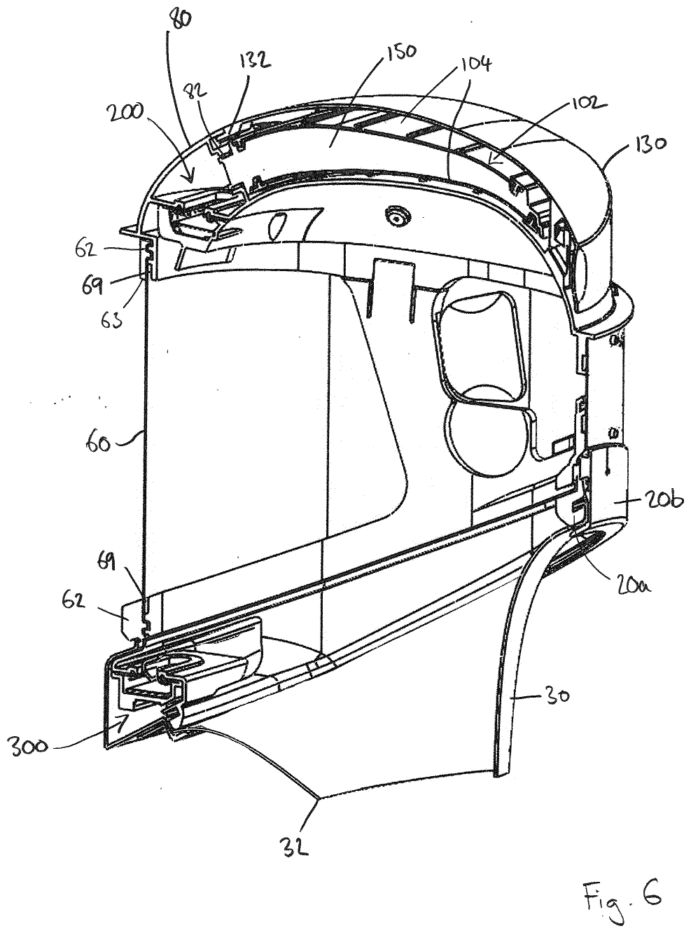

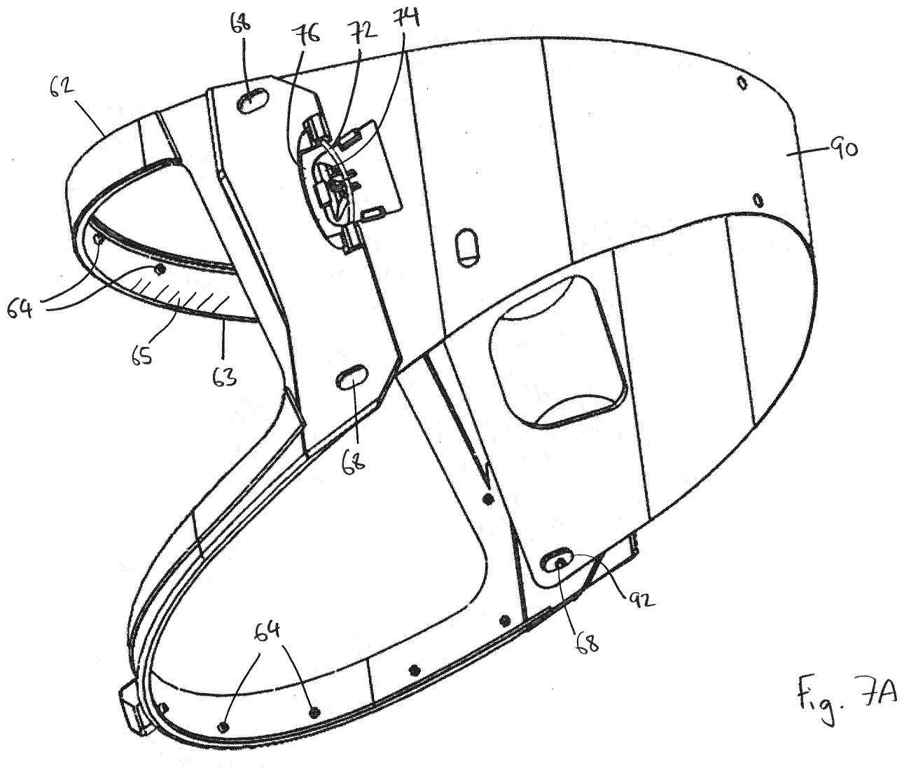

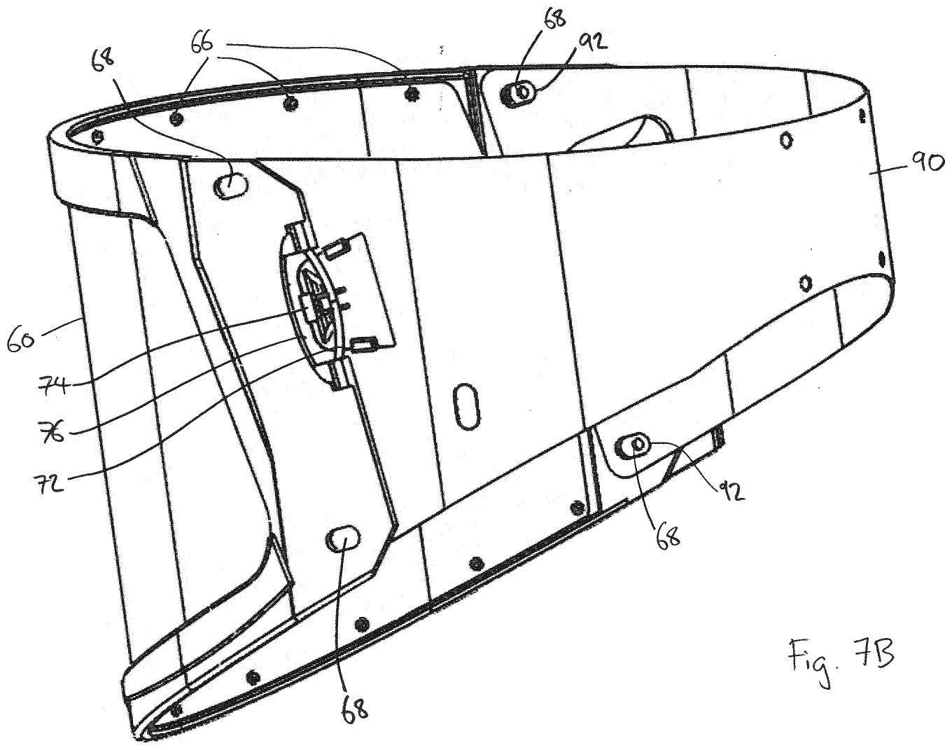

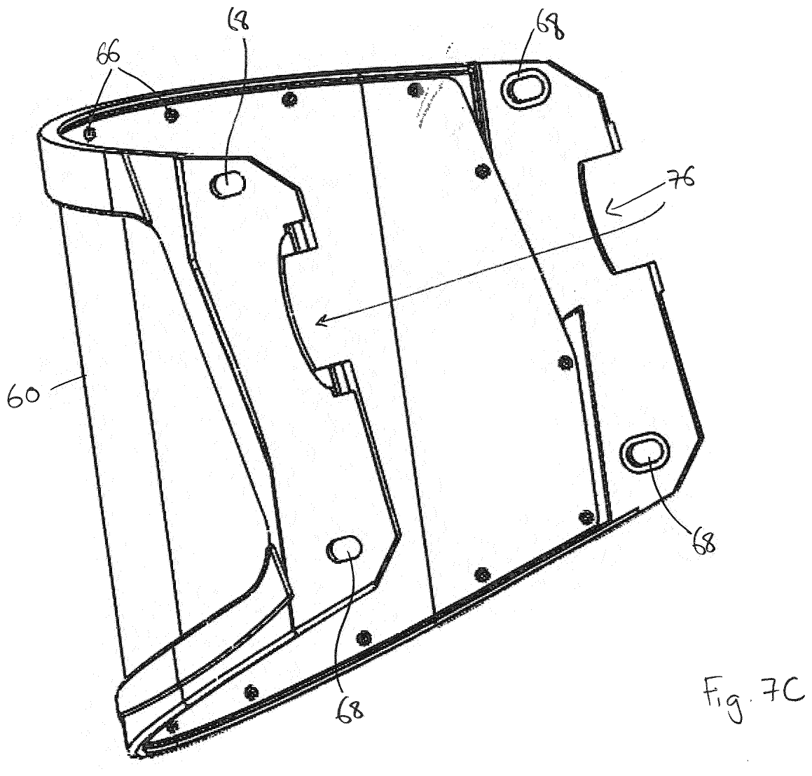

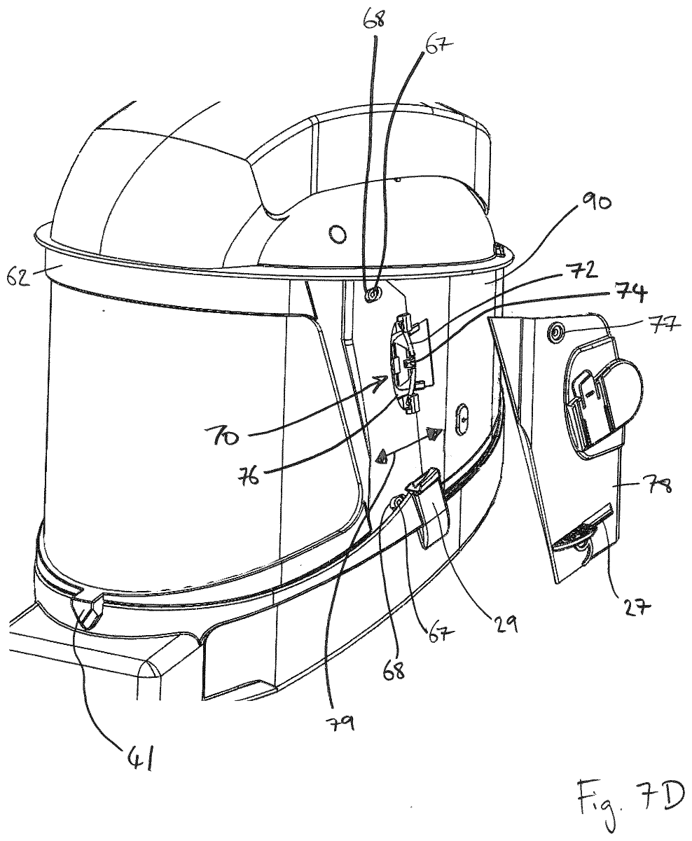

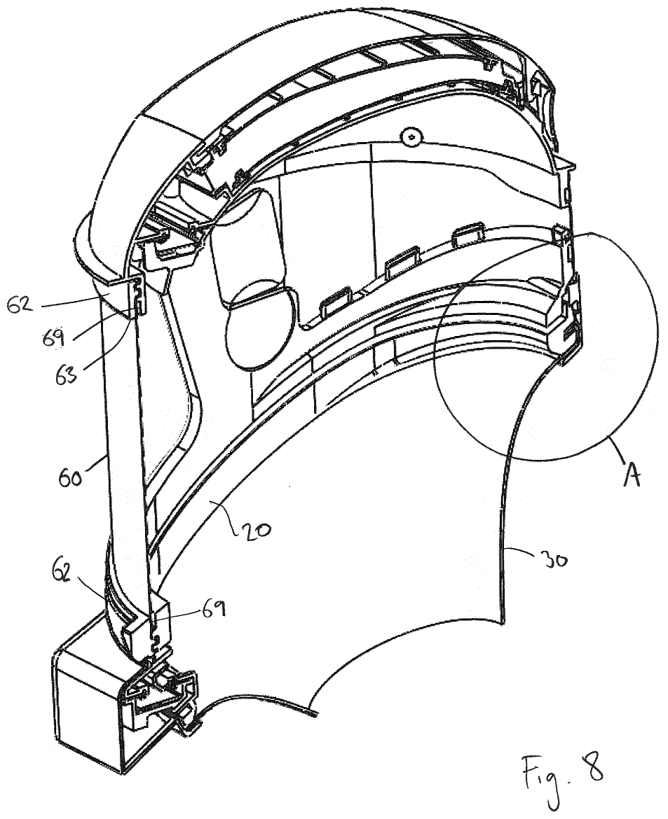

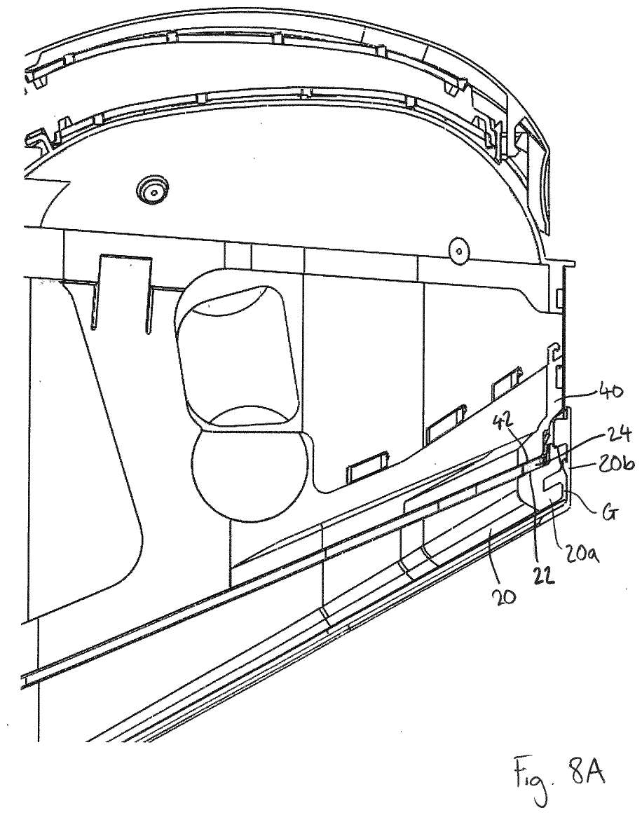

FIGS. 8 and 8A show a cross-section of the apparatus 10, showing in more detail the engagement of the first and second assemblies. FIG. 8A does not show the seal 30 for illustrative purposes, although this would fit into the gap indicated by ‘G’.

The rigid holding member 20 of the first assembly comprises a sealing surface 22 around its upper periphery, and the rigid body 40 of the second assembly comprises a sealing surface 42 around its lower periphery that is configured to oppose the sealing surface 22 of the holding member 20. A resilient/compressible seal member 24 is placed between the sealing surfaces 22, 24.

The apparatus 10 comprises a clip arrangement 28 (see FIG. 7D) at each side of the apparatus, which are each configured to hold the second assembly against the first assembly, and compress the seal member 24 between the sealing surfaces 22, 24 to enclose the interior volume. The clip arrangement 28 comprises a resilient tab 29 on one of the first or second assembly, which is configured to ride over and then clip onto a rigid hook 27 that is connected to the other of the first or second assembly. Upon doing so, the sealing surfaces 22, 42 are urged towards each other and the seal member 24 is compressed to ensure an airtight seal between the two assemblies.

A suitable location feature may be connected to the rigid body 40. In this case a triangular protrusion 41 located in a central position just below the visor 60 (visible in FIG. 7D) is configured to engage with surfaces of a corresponding ‘V’ cut-out in the rigid holding member 20. This can be provided so that the second assembly can be located in the correct position before operating the clip arrangements 28 at the sides of the apparatus 10. That is, a user can engage the front location feature and a corresponding ‘V’ cut-out in the rigid holding member 20, and then seal the first and second assemblies together using the clip arrangements 28 as described above.

The apparatus 10 may comprise additional electronics, for example a microphone adjacent the user's mouth, speakers adjacent the user's ears and a fan adjacent the user's forehead. The fan is configured to blow air around the interior volume. The fan is not required to draw air in through the filter device, which is achieved purely by the user breathing. The apparatus 10 could comprise lights (e.g., LEDs) that are directed forwards, to help aid the user's vision in poor visibility or technical environments. If desired, the apparatus 10 may comprise buttons for operating any of the electronics.

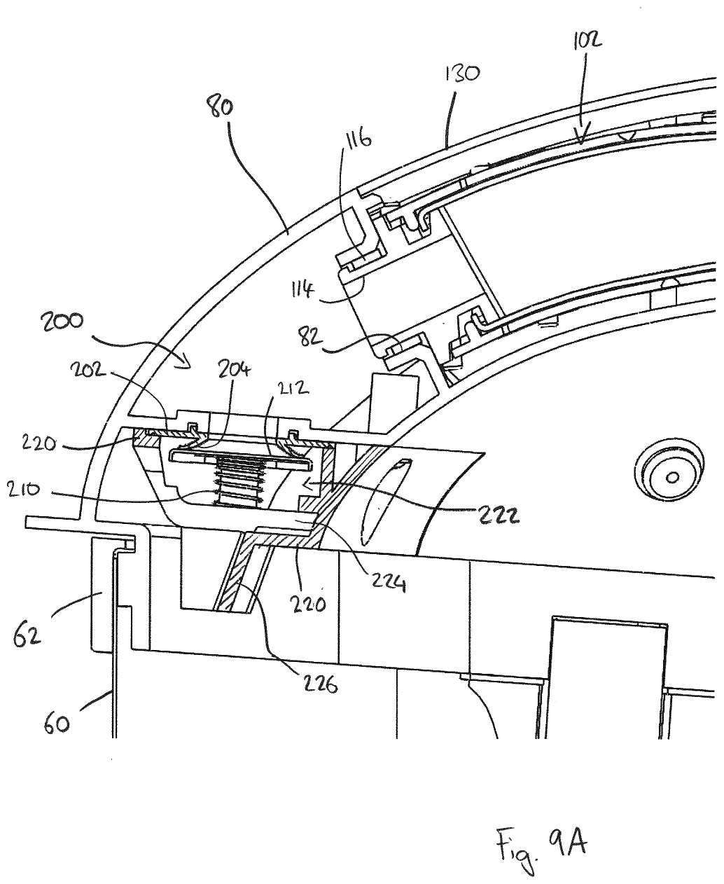

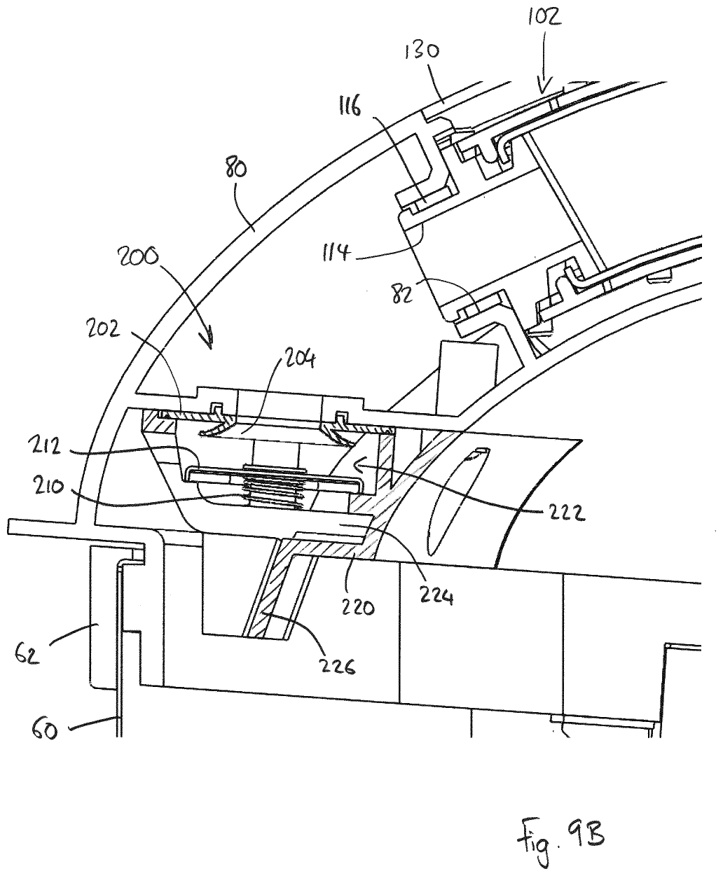

FIG. 9A shows an embodiment of an inlet valve 200 in a closed state (i.e., when a user is not breathing or is exhaling). The inlet valve 200 is positioned downstream of the air inlet 82 and is configured to open to allow airflow into the interior volume 1 upon inhalation of breath, but otherwise close to prevent airflow from passing back through the valve. In the illustrated embodiment this is achieved using a spring-loaded arrangement.

The inlet valve 200 comprises a compliant first sealing member 202 that is held between the rigid cap 80 and a housing/inlet flow guide 220. The first sealing member 202 comprises a thin flange 204 that extends downwards and is configured to seal against an opposing surface.

The inlet guide 220 is a rigid piece held by the cap 80 and configured to hold the parts of the inlet valve 200 in position, and also guide airflow through and out of the valve 200. At opposed ends of the inlet guide 220 there are positioned resilient members 210 (e.g., coil springs, only one is shown in FIG. 9A), each configured to urge a sealing plate 212 against the thin flange 204 of the first sealing member 202 as shown in FIG. 9A. The sealing plate 212 may be any suitable material, although a thin, light metal such as steel or aluminium would be preferred.

Upon inhalation of breath, a pressure difference occurs across the valve 200, such that a slightly lower pressure is found on the downstream side. This pressure difference causes the sealing plate 212 to move against the action of the resilient members 210 to open the valve 200 to the position shown in FIG. 9B. The resilient members 210 have a spring constant that is very light, so that a user only needs to breath in slightly to create a small pressure difference to activate the valve 200.

The inlet guide 220 comprises a cavity 222 configured to hold the first sealing member 202, resilient members 210 and sealing plate 212, wherein movement of the valve 200 to its open position (FIG. 9B) causes air to flow into the cavity 222. From the cavity 222, air will then flow through an aperture 224 in the inlet guide 220 and travel towards the front of the interior volume 1 adjacent to the visor 60. The inlet guide 220 comprises a baffle 226 that extends down from the aperture 224 to act as a flow guide to direct the airflow from the valve against the visor 60. This directs relatively cool, dry air against the visor 60 to help reduce condensation and increase user comfort.

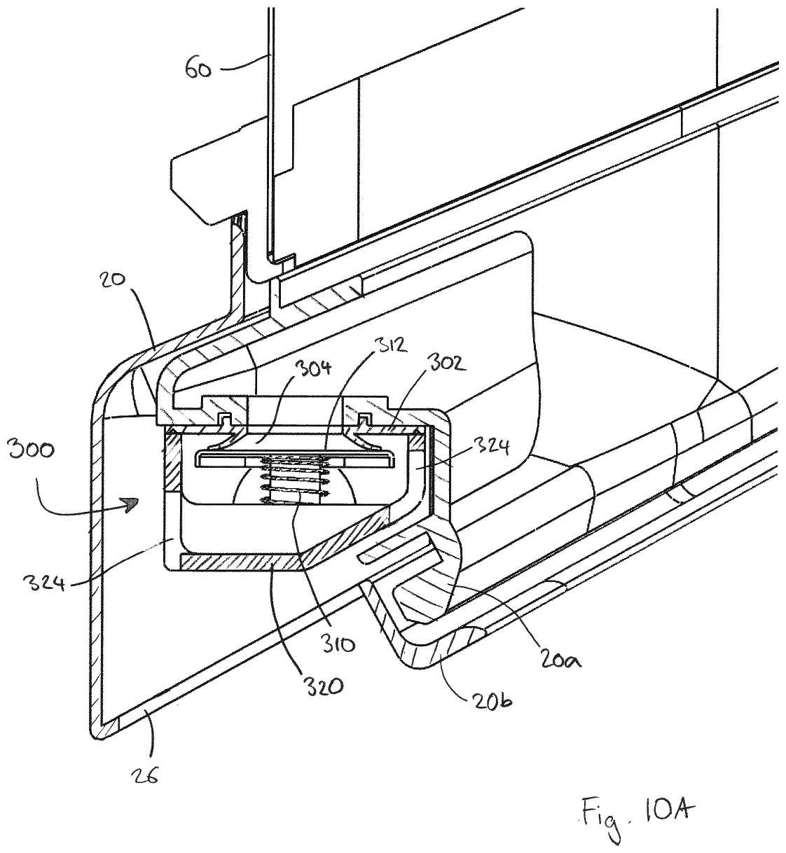

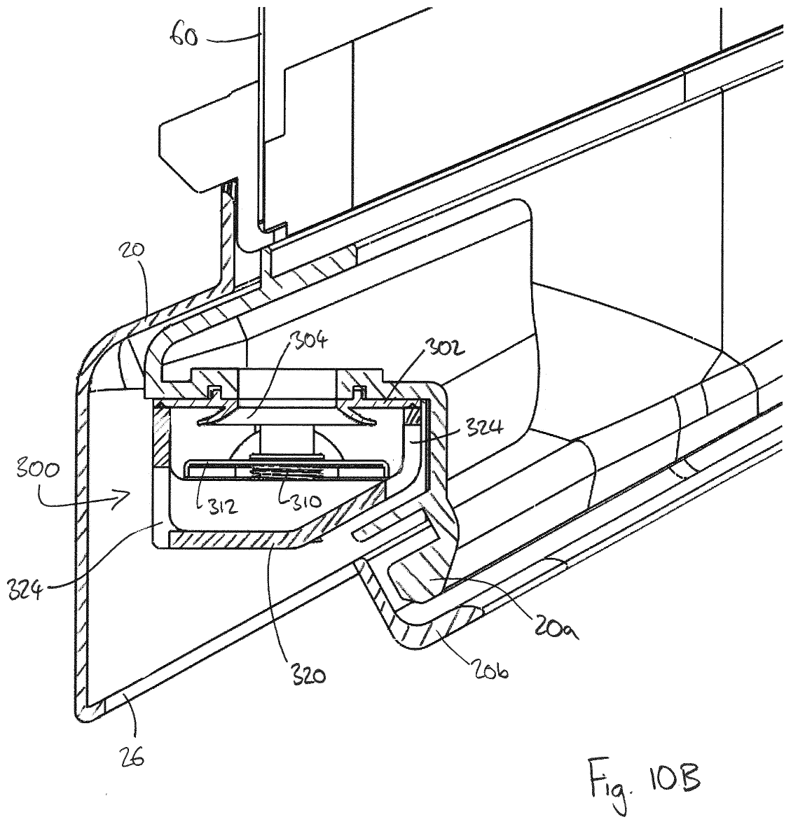

FIG. 10A shows an embodiment of an outlet valve 300 in a closed state (i.e., when a user is not breathing or is inhaling). The outlet valve 300 is substantially similar in construction to the inlet valve, with like elements indicated with like reference numerals with ‘100’ added to them. Thus, the outlet valve 300 comprises a complaint first sealing member 302 with thin flange 304, resilient members 310, sealing plate 312 and housing/outlet flow guide 320.

The operation of the valve 300 is similar, in that upon exhalation of breath, a pressure difference occurs across the valve 300, such that a slightly lower pressure is found on the downstream side. This pressure difference causes the sealing plate 312 to move against the action of the resilient members 310 to open the valve 300 to the position shown in FIG. 10B. The resilient members 310 have a spring constant that is very light, so that a user only needs to breath out slightly to create a small pressure difference to activate the valve 300.

The outlet valve 300 is housed within a portion of the rigid holding member 20, and below the visor 60 adjacent to a user's mouth and chin. This means that exhaled air will exit the outlet valve 300 immediately, such that hot, humid air is expelled from the interior volume 1 as soon as possible. This increases comfort and reduces condensation on the visor 60.

The outlet valve 300 comprises one or more apertures 324 in fluid communication with the external environment via an outlet 26 of the rigid holding member 20.

Although the present invention has been described with reference to various embodiments, it will be understood by those skilled in the art that various changes in form and detail may be made without departing from the scope of the invention as set forth in the accompanying claims.

What is claimed is:

1. An apparatus configured to enclose a volume of air around a user's head, wherein the apparatus is configured to rest on top of the head, extend past the face and sides of the head and seal around the user's neck, and comprises:
a first assembly comprising a rigid holding member and a stretchable seal, wherein the seal extends from the rigid holding member and is configured to seal against the periphery of the user's neck; and
a second assembly comprising a rigid body and a rigid cap, wherein the rigid body is configured to mate with and seal against the rigid holding member of the first assembly, wherein the second assembly further comprises a transparent visor that is held by the rigid body and configured to reveal the user's visage,
wherein the rigid body of the second assembly is configured to extend from the rigid holding member, around the sides and rear of the user's head, and upwards to the rigid cap, which is configured to rest on top of the user's head and carry the apparatus in use, wherein the apparatus further comprises:
at least one air inlet configured to permit air to travel into an interior volume of the apparatus;
at least one inlet valve configured to open and allow air to travel into the interior volume upon inhalation of a user's breath;
at least one outlet valve configured to open and allow air to travel out of the interior volume upon exhalation of a user's breath; and
a filter device that is connected to the rigid cap, and comprises a filter configured to collect, neutralize, kill (or ‘inactivate’) pathogens travelling in an airflow through it,
wherein the apparatus is configured such that air travelling into the interior volume from the external environment during normal breathing has to travel through the air inlet and the filter, and air exiting the interior volume to the external environment during normal breathing has to travel via the outlet valve.

2. The apparatus as claimed in claim 1, wherein the rigid holding member, body and cap form a hard shell.

3. The apparatus as claimed in claim 1, wherein the at least one inlet valve is located downstream of the at least one air inlet to the interior volume of the apparatus, and the filter is located upstream of the at least one air inlet to the interior volume of the apparatus.

4. The apparatus as claimed in claim 1, wherein the rigid holding member comprises a substantially ovoid ring that is configured to extend around a user's chin, wherein each side of the ovoid is configured to follow a respective jawline of the user and meet at the back of their head, such that the rigid holding member is angled downwards from the back of the head to the front when fitted.

5. The apparatus as claimed in claim 1, wherein the filter device comprises a replaceable filter cartridge that plugs into the air inlet to fix it in position.

6. The apparatus as claimed in claim 5, wherein the filter cartridge comprises at least one filter sheet that sits in an airflow path between the interior volume and the surrounding environment, wherein each filter sheet is configured to collect, neutralise, kill (or ‘inactivate’) pathogens travelling in an airflow through it.

7. The apparatus as claimed in claim 6, wherein each filter sheet is held substantially flat between sealed edges.

8. The apparatus as claimed in claim 6, wherein the filter cartridge is a box having two filter sheets superimposed on and separated from each other, so as to form the top and bottom surfaces of the box with a cavity therebetween.

9. The apparatus as claimed in claim 8, wherein the housing comprises an opening in a side of the box that is configured to mate with the air inlet/outlet to fluidly connect the cavity with the interior volume.

10. The apparatus as claimed in claim 9, wherein upon plugging the cartridge into the air inlet, air is able to be drawn from the external environment, through each of the filters and into the cavity therebetween, and then flow from the cavity into the interior volume via the at least one air inlet upon inhalation of a user's breath as aforesaid.

11. The apparatus as claimed in claim 5, wherein the filter device comprises a cover that connects to the rigid cap, and is configured to sit over contours of the cartridge to conceal the filter sheets.

12. The apparatus as claimed in claim 1, wherein the neck seal is an ovoid ring configured to extend in a concentric manner from the rigid holding member to seal against the user's neck.

13. The apparatus as claimed in claim 1, wherein the transparent visor is a continuous sheet of transparent material that is held taut against the rigid body, optionally wherein the visor is a thin, flexible material.

14. The apparatus as claimed in claim 13, wherein the visor is sealed around its periphery to opposing sealing surfaces, and the apparatus comprises a spring-loaded means (e.g., including a resilient member) configured to urge the visor against the sealing surfaces.

15. The apparatus as claimed in claim 14, wherein the second assembly comprises a retainer configured to hold the visor in position in a relatively loose arrangement at first, wherein the retainer further comprises resilient members on each side that cooperate with clips on the rigid body (or vice-versa), wherein each clip is configured to retain a respective resilient member in a tensioned state to pull the retainer closer to the rigid body and press the visor against the opposing sealing surfaces to ensure good sealing contact.

16. The apparatus as claimed in claim 1, wherein the second assembly comprises a sealing plate constructed from highly conductive material to act as a cool internal surface against which condensation will form.

17. The apparatus as claimed in claim 1, wherein the rigid holding member of the first assembly comprises a sealing surface around its upper periphery, and the second assembly comprises a sealing surface around its lower periphery that is configured to mate with the sealing surface of the holding member, and a resilient/compressible seal member is placed between the sealing surfaces to ensure an airtight seal between the two assemblies.

18. The apparatus as claimed in claim 17, wherein the apparatus comprises one or more spring loaded means (e.g., a resilient clip) that is configured to press and hold the second assembly against the first assembly, and compress the seal member placed between the sealing surfaces to enclose the interior volume around the user's head.

19. The apparatus as claimed in claim 1, wherein the apparatus weighs less than about 1 kg.

20. The apparatus as claimed in claim 1, wherein the constituent rigid parts can be repeatedly sterilized.

21. The apparatus as claimed in claim 1, wherein the visor and neck seal are disposable or replaceable items.

22. The apparatus as claimed in claim 1, further comprising one or more electronic devices located within the interior volume.

23. The apparatus as claimed in claim 22, wherein the one or more electronic devices comprises a fan that is configured to blow air around the interior volume, but not substantially draw air into or out from the interior volume.

24. A method of fitting an apparatus as claimed in any preceding claim, the method comprising:
customizing the size of each separate part for an individual's unique head and neck size, for example by dimensioning at least one or all of the neck seal, holding member, rigid body and cap individually for the unique head size, and then the step of constructing the apparatus using the individually dimensioned parts; and
constructing the rigid holding member, rigid body and rigid cap, as well as the stretchable seal and visor, then fitting the stretchable seal to the rigid holding member so that it extends from the rigid holding member and is configured to seal against the periphery of the user's neck as aforesaid, and fitting the visor to the rigid body so that it is held by the rigid body and configured to reveal the user's visage as aforesaid.

25. The system comprising an additive manufacturing device configured to construct the rigid holding member, rigid body and rigid cap of an apparatus as claimed in claim 1.

26. The method of manufacturing an apparatus as claimed in claim 1, the method comprising constructing the rigid holding member, rigid body and rigid cap, as well as the stretchable seal and visor, then fitting the stretchable seal to the rigid holding member so that it extends from the rigid holding member and is configured to seal against the periphery of the user's neck as aforesaid, and fitting the visor to the rigid body so that it is held by the rigid body and configured to reveal the user's visage as aforesaid.

27. The method of manufacturing an apparatus as claimed in claim 1 or a method as claimed in claim 24, the method comprising the step of additively manufacturing (e.g., 3D printing) the rigid holding member, rigid body and rigid cap.

28. The computer program comprising instructions which, when the program is executed by a computer of an additive manufacturing device, cause the additive manufacturing device to additively manufacture the rigid holding member, rigid body and rigid cap of an apparatus as claimed in claim 1.

29. The computer readable storage medium comprising instructions which, when executed by a computer of an additive manufacturing device, cause the additive manufacturing device to additively manufacture the rigid holding member, rigid body and rigid cap of an apparatus as claimed in claim 1.

30. The computer program comprising instructions which, when the program is executed by a computer of an additive manufacturing device, cause the computer to carry out the step of the method of claim 27.

31. The computer readable storage medium comprising instructions which, when executed by a computer of an additive manufacturing device, cause the computer to carry out the step of the method of claim 27.

32. The computer program or computer readable storage medium as claimed in claim 28, wherein the instructions include a CAD model or other digital 3D printable model.

34. A filter cartridge for an item of PPE, the filter cartridge comprising two filter sheets, wherein each filter sheet is configured to collect, neutralize, kill (or ‘inactivate’) pathogens travelling in an airflow through it, wherein each filter sheet is held substantially flat between sealed edges,
wherein the filter cartridge is a box comprising two filter sheets superimposed on and separated from each other, so as to form the top and bottom surfaces of the box with a cavity therebetween,
wherein the box comprises an opening in a side thereof that is configured to mate with the item of PPE to deliver filtered air thereto,
wherein air is able to be drawn from the external environment, through each of the filters and into the cavity therebetween, and then flow out of the cavity via the opening as aforesaid.
